(19) United States
(12) Patent Application Publication
(10) Pub. No.: US 2007/0248332 A1
(43) Pub. Date: Oct. 25, 2007

(54) Image Processing Device, and Image Processing Program

(75) Inventors: Manabu Yata, Ishikawa (JP); Kazunori Sumiya, Ishikawa (JP); Taro Hizume, Ishikawa (JP); Toshiyuki Sano, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 11/574,316

(22) PCT Filed: Aug. 30, 2005
(86) PCT No.: PCT/JP05/15780

§ 371 Date: Feb. 27, 2007

(30) Foreign Application Priority Data
Sep. 3, 2004 (JP) 2004-256671

(51) Int. Cl. H04N 7/64

(52) U.S. Cl. 386/113

(57) ABSTRACT

It is an object of the present invention to provide an image processing device which can reduce time required to eliminate noises in motion pixels, in an image signal processing device using image signals composed of a plurality of frames to enhance a noise eliminating effect.

The image processing device comprises a motion detecting unit 14 for detecting a motion of an image, a cyclic coefficient storing unit 15 for storing therein a cyclic coefficient, a frame cyclic coefficient determining unit 16 for determining a new cyclic coefficient based on a result of the motion detection and the stored cyclic coefficient, and a three-dimensional noise eliminating unit 17 for eliminating noises from the inputted image data and stored image data, in accordance with the cyclic coefficient determined by the frame cyclic coefficient determining unit 16, and in which the frame cyclic coefficient storing unit 15 is operative to store therein a cyclic coefficient determined by the frame cyclic coefficient determining unit 16, thereby making it possible to determine a current cyclic coefficient based on the previous cyclic coefficient, prevent the cyclic coefficient from being rapidly changed from a low value to a high value, and reduce time required to eliminate noises in motion pixels entered in the cyclic frames.

### TECHNICAL FIELD OF THE INVENTION

The present invention relates to an image signal processing device and an image processing program using image signals composed of a plurality of frames to enhance a noise eliminating effect.

### DESCRIPTION OF THE RELATED ART

As a method of eliminating noises from image data taken from an object is known a noise eliminating method of multiplying a plurality of pixels taken at respective times but identical in a two-dimensional position with one another, by a so-called “cyclic coefficient”, and synthesizing the plurality of pixels thus multiplied, for the purpose of reducing the noise components.

The noise eliminating method of this type is quite effective to reduce noise components from image data to the degree that the noise components of more than 9 dB can be reduced with the cyclic coefficient of 0.8 in the case that the image data is indicative of a still object, but on the other hand, causes afterimages in the case that the image data is indicative of a moving object.

As a way to reduce the afterimages is generally adopted an adaptive noise reducing method of judging that the image data is indicative of a moving object if a difference between signal levels of neighboring frames is high, and therefore, lowering the cyclic coefficient, and judging that the image data is indicative of a still object if a difference between signal levels of neighboring frames is low, and therefore, increasing the cyclic coefficient.

FIG. 7 is a block diagram showing a conventional cyclic-type noise reduction device. The conventional cyclic-type noise reduction device will be described hereinlater.

As shown in FIG. 7, the conventional cyclic-type noise reduction device further comprises a voice mode detecting circuit 94 for detecting a scene change based on a change in a voice mode, in addition to a conventional motion adaptive noise reduction unit, and is adapted to set a cyclic coefficient K at zero for a time period of one frame so that a delayed video signal is used when the voice mode detecting circuit 94 detects the scene change, in order to prevent afterimages from being generated (see, for example, patent document 1).
Patent document 1: Japanese Patent Laid-Open Publication No. 2000-224444 (abstract, FIG. 1)

### DISCLOSURE OF THE INVENTION

### PROBLEMS TO BE SOLVED

The conventional adaptive three-dimensional cyclic-type noise reducing device, however, encounters a drawback in that noises may remain for several frames, resulting from the fact that the low cyclic coefficient is set for the pixels, and thus image data having noises are stored in the cyclic frame memory although noise and motion are accurately judged.

Especially, the aforementioned conventional cyclic-time noise reducing device employing a method of lowering the cyclic coefficients applied for the whole screen at the time of the scene change encounters another drawback in that image data having high noise components are stored for all of the cyclic frames and thus influences of the noises may be increased.

The present invention is made with a view to overcoming the previously mentioned drawback, and it is an object of the present invention to provide an image processing device and an image processing program, which can reduce time required to eliminate noises in motion pixels.

### MEANS OF SOLVING THE PROBLEMS

In accordance with a first aspect of the present invention, there is provided an image processing device, comprising: image inputting means for continuously inputting image data; image storing means for storing image data therein; motion detecting means for detecting a motion of an image; cyclic coefficient storing unit for storing therein a cyclic coefficient to be used when referring to stored image data in order to eliminate noises from inputted image data; cyclic coefficient determining means for determining a new cyclic coefficient based on a result of said motion detection and said stored cyclic coefficient; three-dimensional noise eliminating means for eliminating noises from image data inputted by said image inputting means and image data stored in said image storing means, in accordance with said cyclic coefficient determined by said cyclic coefficient determining means, and in which said image storing means is operative to store therein image data whose noises have been eliminated by said three-dimensional noise eliminating means, and said cyclic coefficient storing unit is operative to store therein a cyclic coefficient determined by said cyclic coefficient determining means.

The image processing device according to the present invention thus constructed can reduce time required to eliminate noises in motion pixelsentered in the cyclic frames, resulting from the fact that a previous cyclic coefficient is stored, and a current cyclic coefficient is determined based on not only the motion detection result but also the previous cyclic coefficient, and thus the cyclic coefficient is prevented from being rapidly changed from a low value to a high value.

In the image processing device according to the present invention, said motion detecting means may include whole screen motion detecting means for detecting a motion in the whole screen, and pixel motion detecting means for detecting a motion in units of pixels based on a comparison between said image data inputted by said image inputting means and said image data stored in said image storing means, and said cyclic coefficient determining means may determine said new cyclic coefficient based on said motion in the whole screen, said motion in units of pixels, and said stored cyclic coefficient.

The image processing device according to the present invention thus constructed can prevent the cyclic coefficient from being rapidly increased and thus reduce time required to eliminate noises in motion pixels, resulting from the cyclic coefficient is determined in consideration of the motion in the whole screen.

Further, in the image processing device according to the present invention, said motion detecting means may detect a motion in units of pixels based on a comparison between said image data inputted by said image inputting means and said image data stored in said image storing means, said cyclic coefficient storing unit may store therein cyclic coefficients determined by said cyclic coefficient determining means in units of pixels, and said cyclic coefficient determining means may determine new cyclic coefficients in units of pixels based on said motion in units of pixels, and said stored cyclic coefficients in units of pixels.

The image processing device according to the present invention thus constructed can prevent the cyclic coefficient from being rapidly increased and thus reduce time required to eliminate noises in motion pixels entered in the cyclic frames, resulting from the fact that a previous cyclic coefficient is stored, and a current cyclic coefficient is determined based on not only the motion detection result but also the previous cyclic coefficient, and thus the cyclic coefficient is prevented from being rapidly increased in units of pixels, even though the noises are not caused by whole motion such as, for example, a scene change, but by a moving object partially moved within a screen, resulting from the fact that the cyclic coefficients are stored in units of pixels and used to determine new cyclic coefficients.

Further, in the image processing device, said image storing means may further serve as said cyclic coefficient storing unit and is operative to store therein said cyclic coefficient determined by said cyclic coefficient determining means in one or more lower bits of said image data.

The image processing device according to the present invention thus constructed can prevent the cyclic coefficients in units of pixels from being rapidly increased and thus reduce time required to eliminate noises in motion pixels, even though the noises may be caused by a moving object partially moved within a screen, without adding a memory, for example, a frame memory dedicated to storing the cyclic coefficients therein, even under an environment where the SN ratio may be so deteriorated that signal components cannot be detected from lower bits.

Further, in the image processing device according to the present invention, said three-dimensional noise eliminating means may eliminate noises in such a way that said image data inputted by said image inputting means is synthesized with said image data stored in said image storing means in accordance with said cyclic coefficient determined by said cyclic coefficient determining means, and said cyclic coefficient determining means may determine a new cyclic coefficient based on a result of said motion detection and said stored cyclic coefficient in accordance with a synthesizing ratio of a previous frame image stored in said image storing means and a synthesizing ratio of a current frame image inputted by said image inputting means, in said image data whose noises have been eliminated by said three-dimensional noise eliminating means.

The image processing device according to the present invention thus constructed can promptly eliminate the noises in the cyclic frame by setting an upper limit on the cyclic coefficient. Here, the synthesizing ratios are intended to mean ratios of respective frame images, contained in image data calculated after being multiplied by the cyclic coefficient, to the image data.

In accordance with a second aspect of the present invention, there is provided an image processing program, comprising: an image inputting step of continuously inputting image data; a motion detecting step of detecting a motion of said inputted image data; a cyclic coefficient determining step of determining a new cyclic coefficient based on a result of said motion detection and a stored cyclic coefficient; a three-dimensional noise eliminating step of eliminating noises from said image data inputted in said image inputting step and said stored image data in accordance with said cyclic coefficient determined in said cyclic coefficient determining step, an image storing step of storing said image data whose noises have been eliminated in said three-dimensional noise eliminating step, and a cyclic coefficient storing step of storing said cyclic coefficient determined in said cyclic coefficient determining step, and in which said cyclic coefficient determining step has a step of determining a new cyclic coefficient based on said result of said motion detection detected in said motion detecting step and said cyclic coefficient stored in said cyclic coefficient storing step, said three-dimensional noise eliminating step has a step of eliminating noises from said image data inputted in said image inputting step and said image data stored in said image storing step in accordance with said cyclic coefficient determined in said cyclic coefficient determining step, and said image inputting step, said motion detecting step, said cyclic coefficient determining step, said three-dimensional noise eliminating step, said image storing step, and said cyclic coefficient storing step are repeated.

The image processing program according to the present invention thus constructed can reduce time required to eliminate noises in motion pixelsentered in the cyclic frames, resulting from the fact that a previous cyclic coefficient is stored, and a current cyclic coefficient is determined based on not only the motion detection result but also the previous cyclic coefficient, and thus the cyclic coefficient is prevented from being rapidly changed from a low value to a high value.

Further, in the image processing program according to the present invention, said three-dimensional noise eliminating step may have a step of eliminating noises in such a way that said image data inputted in said image inputting step is synthesized with said image data stored in said image storing step in accordance with said cyclic coefficient determined in said cyclic coefficient determining step, and said cyclic coefficient determining step may have a step of determining a new cyclic coefficient based on said result of said motion detection and said stored cyclic coefficient in accordance with a synthesizing ratio of a previous frame image stored in said image storing step and a synthesizing ratio of said current frame image inputted in said image inputting step, with respect to said image data whose noises have been eliminated in said three-dimensional noise eliminating step.

### EFFECT OF THE INVENTION

In accordance with the present invention, there is provided an image processing device according to the present invention which can reduce time required to eliminate noises in motion pixels entered in the cyclic frames, resulting from the fact that a previous cyclic coefficient is stored, and a current cyclic coefficient is determined based on not only the motion detection result but also the previous cyclic coefficient, and thus the cyclic coefficient is prevented from being rapidly changed from a low value to a high value, resulting from the fact that the image processing device comprises cyclic coefficient storing means for storing therein a cyclic coefficient determined by cyclic coefficient determining means, and cyclic coefficient determining means for determining a new cyclic coefficient based on a result of the motion detection and the stored cyclic coefficient.

### BRIEF DESCRIPTION OF THE DRAWINGS

FIG. 1 is a block diagram showing a first preferred embodiment of an image processing device according to the present invention.

FIG. 2 is a table showing a comparison between noise amounts remained in frames in respective cyclic coefficient control methods.

FIG. 3 is a block diagram showing a second preferred embodiment of an image processing device according to the present invention.

FIG. 4 is a block diagram showing a third preferred embodiment of an image processing device according to the present invention.

FIG. 5 is a block diagram showing a fourth preferred embodiment of an image processing device according to the present invention.

FIG. 6 is a flow chart explaining an operation carrying out a fifth preferred embodiment of an image processing program according to the present invention.

FIG. 7 is a block diagram showing a conventional cyclic-type noise reduction device.

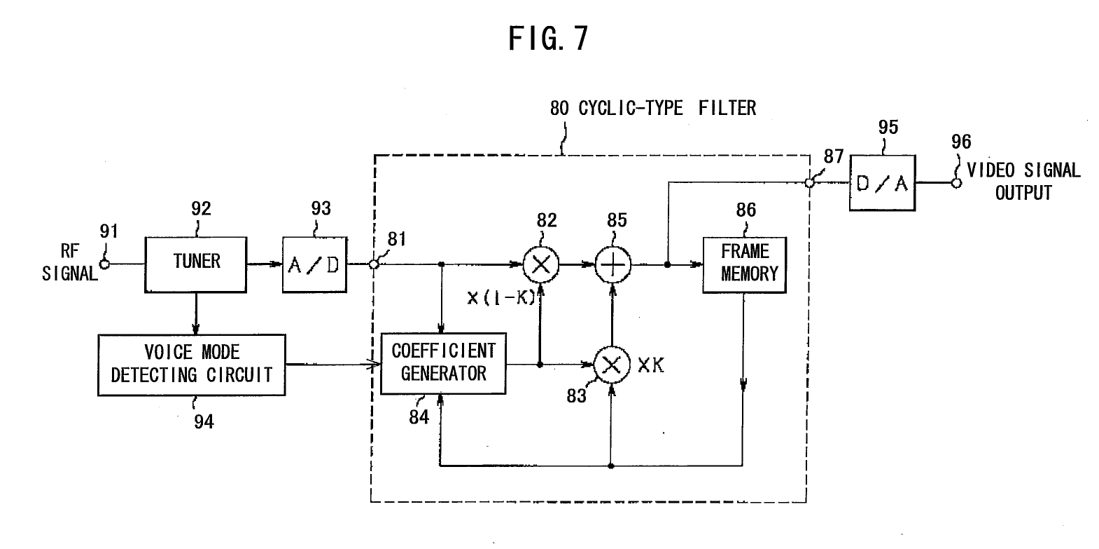

### EXPLANATION OF THE REFERENCE NUMERALS

10, 20, 30, 40 image processing device
11, 21, 31, 41 image inputting unit (image inputting means)
12, 22, 32 frame storing unit (image storing unit)
13, 23, 33, 43 image synchronizing unit
14 motion detecting unit (motion detecting means)
15, 25, 35 frame cyclic coefficient storing unit (cyclic coefficient storing means)
16, 26, 36, 46 frame cyclic coefficient determining unit (cyclic coefficient determining means)
17, 27, 37, 47 three-dimensional noise eliminating unit (three-dimensional noise eliminating means)
24 whole motion detecting unit (whole screen motion detecting means)
28 pixel motion detecting unit (pixel motion detecting means)
38, 48 pixel motion detecting unit (motion detecting means)
42 frame storing unit (image storing means, cyclic coefficient storing means)
61 frame number
62 motion adaptive type cyclic coefficient
63 motion adaptive type noise amount
64 improved type cyclic coefficient
65 improved type noise amount

### DESCRIPTION OF THE PREFERRED EMBODIMENTS

A plurality of preferred embodiments of image processing device according to the present invention will now be described hereinlater with reference to the drawings.

### First Preferred Embodiment

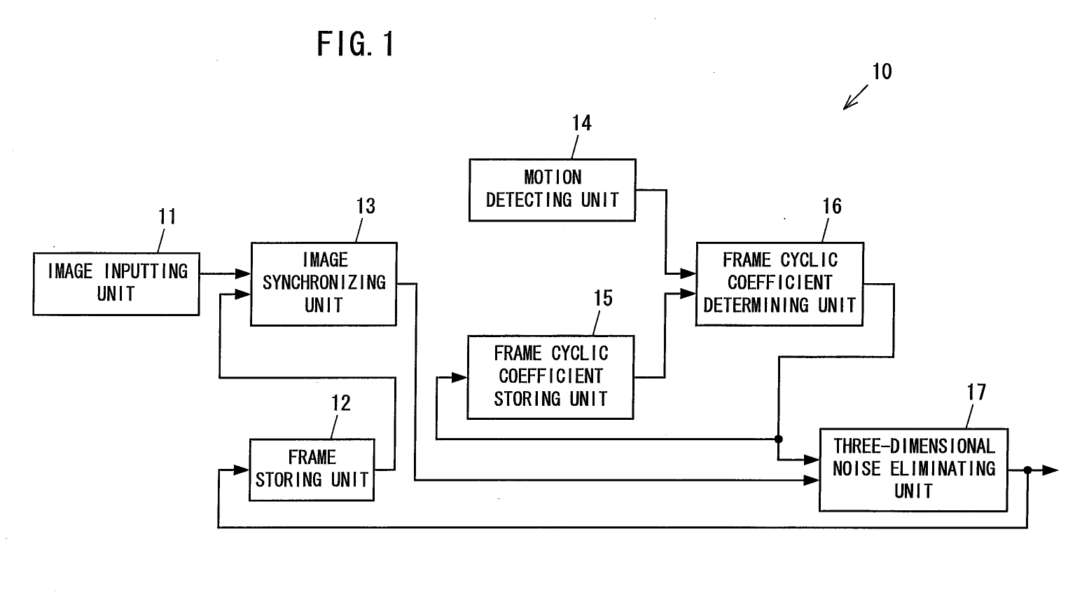

Referring to FIG. 1 of the drawings, there is shown a first preferred embodiment of the image processing device according to the present invention. It is herein assumed that the image processing device shown in FIG. 1 is constituted by an LSI circuit having a RAM capable of storing therein image data of one frame, and adapted to sequentially process image data inputted in units of pixels and output the processed image data in units of pixels.

As clearly shown in FIG. 1, the image processing device 10 comprises an image inputting unit 11 (image inputting means) for continuously inputting image data, a frame storing unit 12 (image storing means) for storing image data therein, an image synchronizing unit 13 for reading the image data stored in the frame storing unit 12 in synchronization with the image data outputted from the image inputting unit 11, a motion detecting unit 14 (motion detecting means) for detecting a motion of the image data, a frame cyclic coefficient storing unit 15 (cyclic coefficient storing means) for storing therein a frame cyclic coefficient, a frame cyclic coefficient determining unit 16 (cyclic coefficient determining means) for determining a frame cyclic coefficient based on the stored frame cyclic coefficient and a result of the motion detection, and a three-dimensional noise eliminating unit 17 (three-dimensional noise eliminating means) for eliminating noises from the image data from the image inputting unit 11 and the image data from the frame storing unit 12 in accordance with the frame cyclic coefficient.

Further, the frame storing unit 12 is designed to store therein the image data whose noises have been eliminated by the three-dimensional noise eliminating unit 17, and the frame cyclic coefficient storing unit 15 is designed to store therein the frame cyclic coefficient determined by the frame cyclic coefficient determining unit 16.

The description hereinlater will be directed to the operation of the image processing device 10 hereinlater.

Firstly, the image inputting unit 11 is operated to input therethrough image data (hereinlater simply referred to as “current frame image”) from outside thereof, in units of pixels. Then, the image synchronizing unit 13 is operated to read the old image data (hereinlater simply referred to as “previous frame image”) from the frame storing unit 12, in synchronization with the image data outputted from the image inputting unit 11.

The motion detecting unit 14 is operated to detect a motion of the whole image based on, for example, control information of a turntable on which an imaging deice for taking the image is placed, a direction detected by a gyro, and/or the like. Further, the motion detecting unit 14 may detect a motion of the image based on frame correlations of the image signal. The frame cyclic coefficient storing unit 15 is adapted to store therein a frame cyclic coefficient determined for the image data of the previous frame.

The frame cyclic coefficient determining unit 16 is operated to determine a frame cyclic coefficient based on a result of the motion detection made by the motion detecting unit 14 and the frame cyclic coefficient of the previous frame stored in the frame cyclic coefficient storing unit 15. The ratio of the image data of the previous frame to the image data stored in the frame storing unit 12 becomes higher as the frame cyclic coefficient is increased. This means that, in the case that the previous frame cyclic coefficient is greatly decreased, an upper limit is set on frame cyclic coefficients to be applied the next time onward so as to eliminate the noises remained in the cyclic frames stored in the frame storing unit 12, because motion is detected in the previous frame image, and thus noises in the cyclic frame are large. Further, the frame cyclic coefficient thus determined is stored in the frame cyclic coefficient storing unit 15.

The three-dimensional noise eliminating unit 17 is adapted to carry out a three-dimensional noise eliminating operation in such a way that a target pixel of the current frame image and a target pixel of the previous frame image, identical in a two-dimensional position to each other, are processed with the frame cyclic coefficient determined by the frame cyclic coefficient determining unit in accordance with the expression as follows.
(Current Frame Image)−(Current Frame Image−Previous Frame Image)×Frame Cyclic Coefficient

Then, the image data thus obtained is stored in the frame storing unit 12.

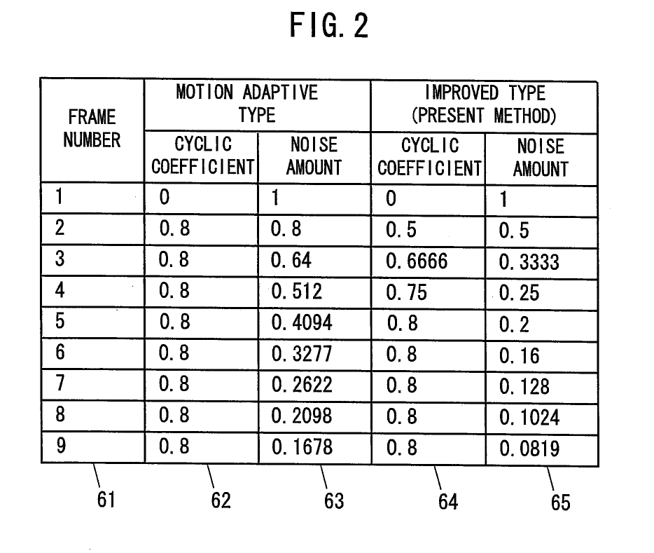

The description hereinlater will be directed to processes of determining a frame cyclic coefficient carried out by the frame cyclic coefficient determining unit 16 with reference to FIG. 2. FIG. 2 is a table showing how noise amounts are eliminated in the respective cases of adopting a conventional motion adaptive method and an improved method (according to the present invention) under the assumption that a motion is detected in a frame of the frame number 61 being equal 1, and then no motion is detected in subsequent frames. It is further assumed that the cyclic coefficient is set at

0 when motion is detected and set at 0.8 when no motion is detected in the conventional motion adaptive method.

As clearly shown in FIG. 2, in the conventional motion adaptive method, the cyclic coefficient 62 is set at 0 for the first frame (frame number 61 is equal to 1) because motion is detected and at 0.8 for frames (frame number 61 is equal to 2 or greater) subsequent to the first frame because no motion is detected. The noise amount 63 is indicated as being a ratio of noise amount remained in each of frames under the condition that the noise amount 63 of the first frame is equal to 1. The noise amount 63 remained in the frames is gradually decreased in such a manner that 1×0.8=0.8 is for the second frame, 0.8×0.8=0.64 is for the third frame, and the like.

The fact that the cyclic coefficient is set at 0.8 for a still image leads to the fact that the current frame image is multiplied by a coefficient set at 0.2. This means that the noise eliminating method is targeted at reducing the noise amount remained in the cyclic frame to, for example, 0.2 or less. In the conventional motion adaptive method, the noise amount remained in the frames becomes less than 0.2 at the ninth frame. From the foregoing description, it is to be understood that it takes a long time to eliminate the noise remained in the cyclic frame because the conventional motion adaptive method is aimed at eliminating noises caused by motion but does not consider a possibility of entering noises into the cyclic frames.

The image processing device according to the present invention, on the other hand, is aimed at promptly eliminating the noise remained in the cyclic frame by setting an upper limit on frame cyclic coefficients. It is preferable that the cyclic coefficient is set so that the noise amounts are averagely distributed under the assumption that the noise amounts in respective frames are, for example, equal to one another. The three-dimensional noise eliminating unit 17 is adapted to eliminate noises in such a way that the current frame image is synthesized with the previous frame image in accordance with the cyclic coefficient. Accordingly, the frame cyclic coefficient determining unit 16 may determine a frame cyclic coefficient, for example, in such a manner that a synthesizing ratio of the previous frame image to the image data would not far exceed a synthesizing ratio of the current frame image to the image data. In the concrete, the upper limit can be calculated on the basis of a previous cyclic coefficient in accordance with Expression (1) as follows. Here, the previous cyclic coefficient is intended to mean a cyclic coefficient of the previous frame, viz., one frame prior to the current frame stored in the frame cyclic coefficient storing unit 15.
Cyclic Coefficient Upper limit*(1−Previous Cyclic Coefficient) =1−Cyclic Coefficient Upper limit (1)
Expression (2) is derived from Expression (1) Cyclic Coefficient Upper Limit=1/(2−Previous Cyclic Coefficient) (2)

The cyclic coefficient 64 appearing in the table shown in FIG. 2 is calculated in accordance with the above-mentioned method, viz., improved method, and the noise amount 65 appearing in the table shown in FIG. 2 indicates how the noises remained in the cyclic frames are eliminated. It will be understood that the noise amount is reduced to equal to or less than the target value of 0.2 at the fifth frame.

While it has been described in the above about the case that the cyclic coefficient is a real number, the cyclic coefficient may be normalized and processed as being an integral number. Further, divisions may be in advance computed and the result of divisions may be stored as a table, so that the dividing computation may be simplified in such a manner of searching the result from the table.

Further, while it has been described in the above that the cyclic coefficient is set at 0 when motion is detected and set at 0.8 when no motion is detected, in the image processing, it is difficult to detect whether the image is in motion or still with high accuracy. In many systems, “appearing to be in motion” or “appearing to be still” are represented in multi-digit value such as, for example, 16 digit value, 256 digit value, instead of binary digit value. Further, the cyclic coefficients, which are derived from the “appearing to be in motion” may be represented in multi-digit value. The present invention is applicable to not only the result of motion detection and the cyclic coefficient represented in binary digit value, but also the result of motion detection and the cyclic coefficient represented in multi-digit value.

While it has been described in the present embodiment that the frame cyclic coefficient determining unit 16 calculates the upper limit of the cyclic coefficient in accordance with the Expression (1) or (2), and determines the cyclic coefficient in such a manner that the cyclic coefficient does not exceed the upper limit, the Expressions (1) and (2) are just examples. It is needless to mention that the frame cyclic coefficient determining unit 16 may use any means other than the Expression (1) or (2) as long as the frame cyclic coefficient determining unit 16 can determine such a cyclic coefficient that the synthesizing ratio of the previous frame image to the image data will not far exceed a synthesizing ratio of the current frame image to the image data. The frame cyclic coefficient determining unit 16 may determine such a cyclic coefficient that the synthesizing ratio of the previous frame image to the image data will not far exceed a synthesizing ratio of the current frame image to the image data in consideration of characteristics of noises, constituent devices, and the like.

As will be appreciated from the foregoing descriptions, it will be understood that the present embodiment of the image processing device can reduce time required to eliminate noises in motion pixels, resulting from the fact that a previous cyclic coefficient is stored, an upper limit is calculated, and a current cyclic coefficient is determined based on not only the motion detection result but also the previous cyclic coefficient, and thus the cyclic coefficient is prevented from being rapidly changed from a low value to a high value.

### Second Preferred Embodiment

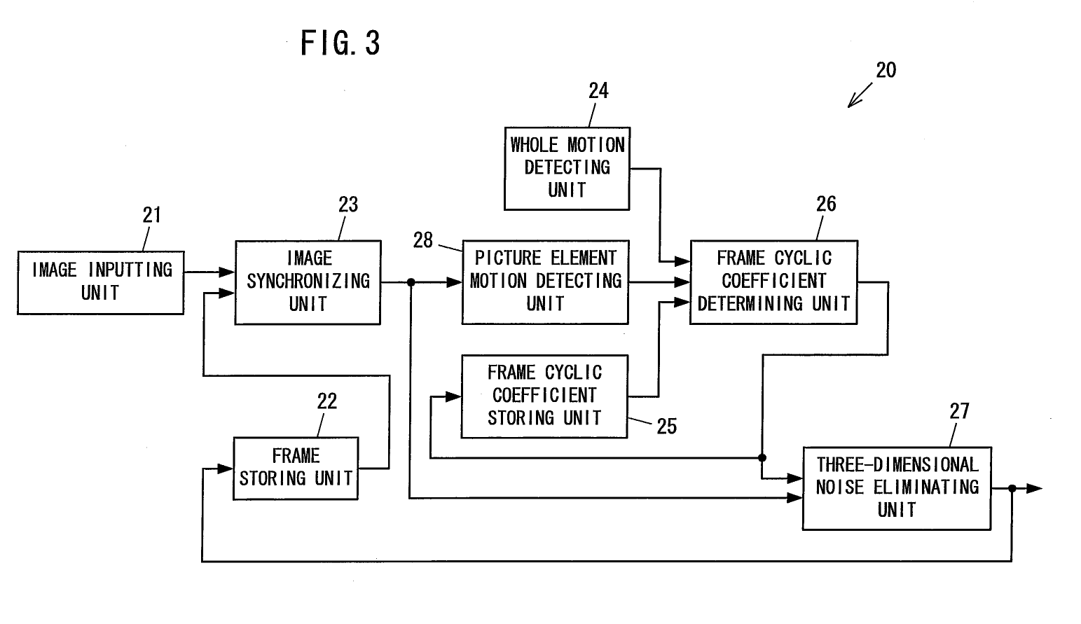

Then, referring to FIG. 3 of the drawings, there is shown a second preferred embodiment of the image processing device according to the present invention.

As clearly shown in FIG. 3, the image processing device 20 comprises, in addition to an image inputting unit 21 (image inputting means), a frame storing unit 22 (image storing means), an image synchronizing unit 23, a frame cyclic coefficient storing unit 25 (cyclic coefficient storing means), a frame cyclic coefficient determining unit 26 (cyclic coefficient determining means), and a three-dimensional noise eliminating unit 27, which are the same in construction as those of the first embodiment. The image processing device 20 further comprises a whole motion detecting unit 24 (whole screen motion detecting means) for detecting a motion in the whole screen, and a pixel motion detecting unit 28 (pixel motion detecting means) for detecting a motion of an image as a result of comparison between the image data inputted by the image inputting unit 21 and the image data stored in the frame storing unit 22 in units of pixels.

The present embodiment is characterized in that motion is detected in two methods including a first method of detecting a motion of the whole screen and a second method of detecting a motion in units of pixels based on a difference between frames.

The description hereinlater will be directed to the present embodiment of the image processing device 20 mainly different from the first embodiment of the image processing device 10.

The whole motion detecting unit 24 is the same as the motion detecting unit 14 shown in FIG. 1 and adapted to detect a motion of the whole screen based on, for example, control information of a turntable on which an imaging deice for taking the image is placed, a direction detected by a gyro, and/or the like. Further, the whole motion detecting unit 24 may detect a motion of the whole screen based on frame correlations of the image signal.

The pixel motion detecting unit is adapted to detect whether a motion is occurred based on a difference between a current frame and a previous frame synchronized with each other by the image synchronizing unit 23.

The frame cyclic coefficient determining unit 26 is operated to determine a cyclic coefficient based on a result of the motion detection made by the whole motion detecting unit 24, and the cyclic coefficient thus determined is stored in the frame cyclic coefficient storing unit 25. In addition, cyclic coefficients are determined based on a result of the motion detecting made in units of pixels. An upper limit of the cyclic coefficient is calculated based on the cyclic coefficient determined based on the result of the motion detection made by the whole motion detecting unit 24. Further, the cyclic coefficients are corrected in accordance with the cyclic coefficient stored in the frame cyclic coefficient unit 25 in the same manner as described in the first embodiment.

As will be appreciated from the foregoing descriptions, it will be understood that, in the present embodiment of the image processing device, a current cyclic coefficient is further restricted in consideration of the motion in the whole screen, thereby preventing the cyclic coefficients in units of pixels from being rapidly changed from a low value to a high value, and thus enabling to reduce time required to eliminate noises in motion pixels.

### Third Preferred Embodiment

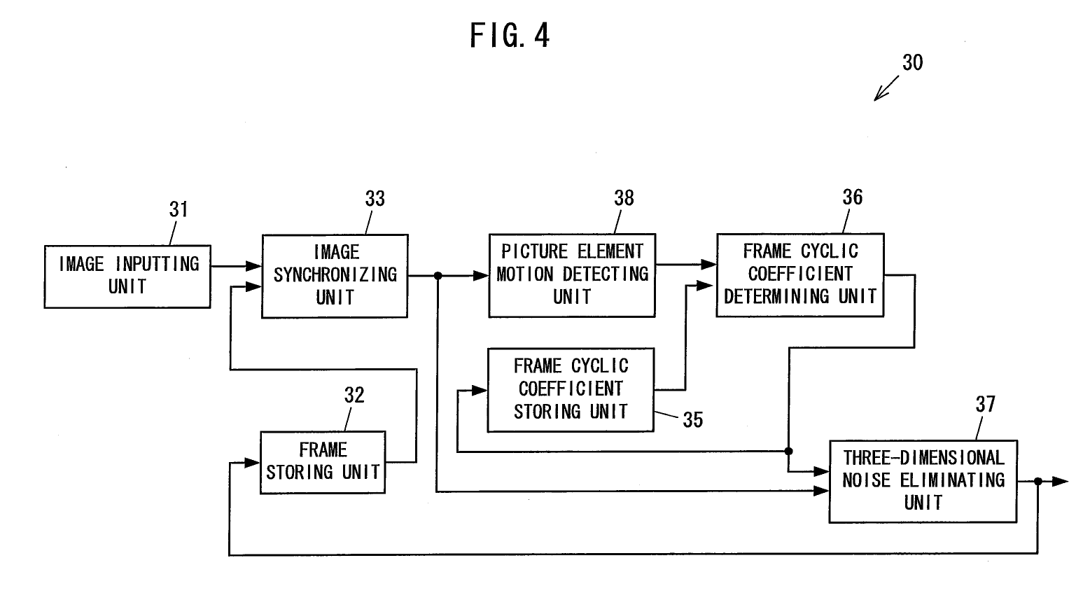

Then, referring to FIG. 4 of the drawings, there is shown a third preferred embodiment of the image processing device according to the present invention.

As clearly shown in FIG. 4, the image processing device 30 comprises an image inputting unit 31 (image inputting means), a frame storing unit 32 (image storing means), an image synchronizing unit 33, a frame cyclic coefficient storing unit 35 (cyclic coefficient storing means), a frame cyclic coefficient determining unit 36 (cyclic coefficient determining means), a three-dimensional noise eliminating unit 37, and a pixel motion detecting unit 38 (motion detecting means), which are the same in construction as those of the second embodiment.

The present embodiment is characterized in that the frame cyclic coefficient storing unit 35 is adapted to store therein cyclic coefficients in units of pixels.

The description hereinlater will be directed to the present embodiment of the image processing device 30 mainly different from the second embodiment of the image processing device 20.

In the present embodiment, the cyclic coefficients can be stored in units of the pixels. Accordingly, the whole motion detecting unit 24 shown in FIG. 3 is not essential.

The frame cyclic coefficient determining unit 36 is adapted to calculate upper limits of cyclic coefficients respectively based on previous cyclic coefficients stored in the frame cyclic coefficient storing unit 35 in units of pixels, and correct the cyclic coefficients in the same manner as described in the first embodiment. The cyclic coefficients thus obtained are stored in the frame cyclic coefficient storing unit 35 in units of pixels.

As will be appreciated from the foregoing description, it will be understood that the present embodiment of the image processing device according to the present invention can prevent cyclic coefficients in units of pixels from being rapidly changed and thus reduce time required to eliminate noises in motion pixels, even though the noises are not caused by whole motion such as, for example, a scene change, but by a moving object partially moved within a screen, resulting from the fact that cyclic coefficients are stored in units of pixels, and current cyclic coefficients are determined in accordance with the previous cyclic coefficients thus stored.

The cyclic coefficient used to eliminate the noise determines a ratio of the image data of the previous frame to the image data of the current frame in the image data which has been synthesized and whose noises have been eliminated by the three-dimensional noise eliminating unit 37, and thus directly affect the image quality of the image data outputted from the three-dimensional noise eliminating unit 37. Bit width of the cyclic coefficient is, for example, narrow, pseudo tone may occur at a turn of the cyclic coefficient, and accordingly noises may be generated. However, the cyclic coefficient stored in the frame cyclic coefficient storing unit 35 is to be exclusively used to determine the upper limit of the cyclic coefficient, and thus, may be less in bit width than the cyclic coefficient to be actually used by the three-dimensional noise eliminating unit 37. This means that the bit width of the coefficient to be actually used by the three-dimensional noise eliminating unit 37 is required to be 4 bits or greater because it will affect the image quality of the image data. The bit width of the coefficient to be stored in the frame cyclic coefficient storing unit 35, on the other hand, may be 2 or 3 bits if it is exclusively used to calculate the upper limit as will be described from the following embodiment.

### Fourth Preferred Embodiment

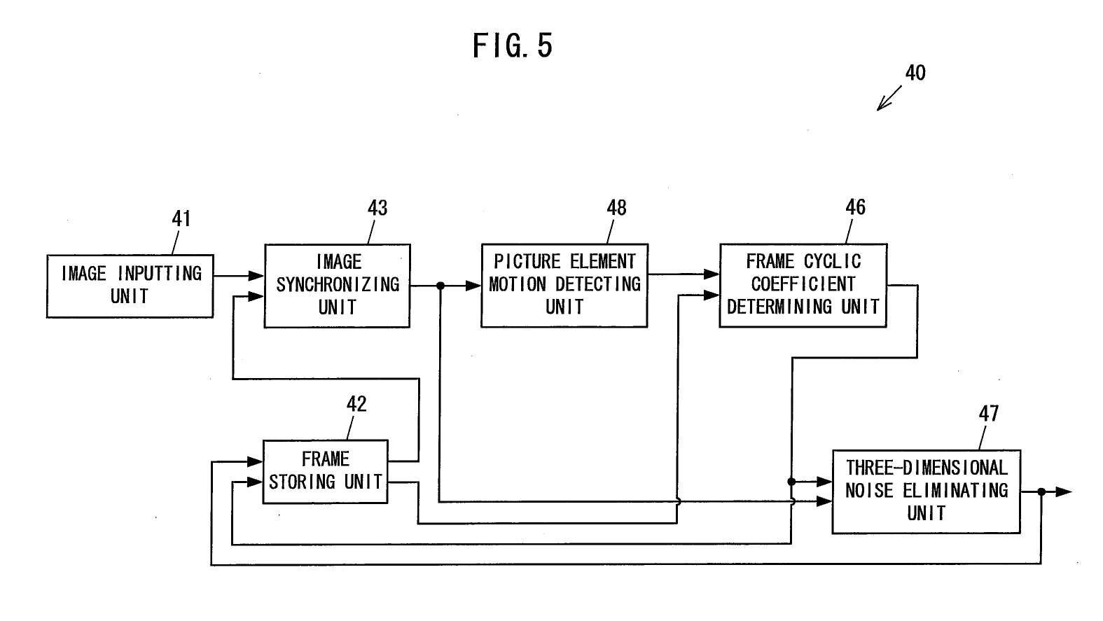

Then, referring to FIG. 5 of the drawings, there is shown a fourth preferred embodiment of the image processing device according to the present invention.

As clearly shown in FIG. 5, the image processing device 40 comprises an image inputting unit 41 (image inputting means), a frame storing unit 42 (image storing means, cyclic coefficient storing means), an image synchronizing unit 43, a frame cyclic coefficient determining unit 46 (cyclic coefficient determining means), a three-dimensional noise eliminating unit 47, and a pixel motion detecting unit 48 (motion detecting means), which are the same in construction as those of the third embodiment.

The present embodiment is characterized in that the cyclic coefficients are stored in the frame storing unit 42 in place of the frame cyclic coefficient storing unit 35.

The description hereinlater will be directed to the present embodiment of the image processing device 40 mainly different from the third embodiment of the image processing device 30.

In the present embodiment, the cyclic coefficients stored in the frame storing unit 42 are used by the frame cyclic coefficient determining unit 46 to correct the cyclic coefficients, and the cyclic coefficients thus corrected are stored in the frame storing unit 42, thereby carrying out the same processes as the previous embodiment eliminating the need of the frame cyclic coefficient storing unit 35.

This method is effective in the case that the SN ratio is low, for example, when a gain of the image data is increased in a low-illuminance environment because the cyclic coefficients can be stored in one or more lower bits of the image data, which contain noise components and thus invalid, thereby making efficient use of the cyclic frame memory.

On the other hand, in the case that the SN ratio is high, the cyclic coefficients are low, and therefore not required to be corrected. This means that in the case that the SN ratio is high, the one or more lower bits of the image data are used for its intended purpose of storing the image data therein. As the SN ratio becomes deteriorated, invalid lower bits are increased, and the invalid bit width is used to store the cyclic coefficients therein.

The present embodiment of the image processing device according to the present invention can prevent the cyclic coefficients in units of pixels from being rapidly increased and thus reduce time required to eliminate noises in motion pixels, even though the noises may be caused by a moving object partially moved within a screen, without adding a memory such as, for example, a frame memory dedicated to storing the cyclic coefficients therein.

Further, the present embodiment of the image processing device according to the present invention may be constituted by, for example, a processor, a memory, electric circuits, and/or the like, or program modules to be carried out by, for example, a processor, as will be described from the following embodiment.

### Fifth Preferred Embodiment

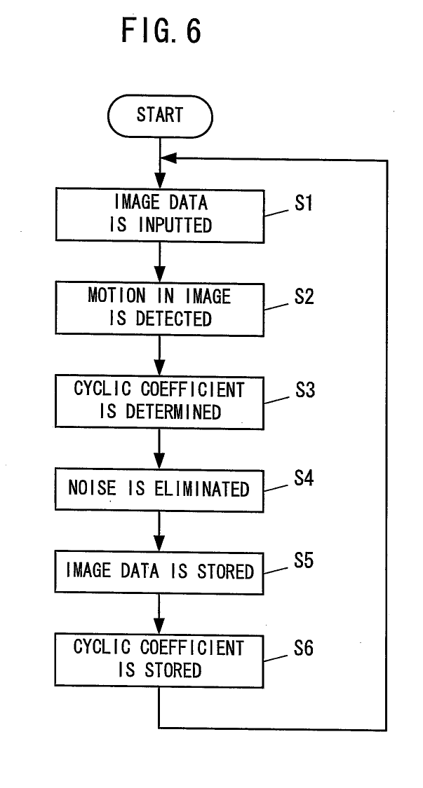

Then, referring to FIG. 6 of the drawings, there is shown a fifth preferred embodiment of an image processing program according to the present invention.

The image processing program comprises an image inputting step of continuously inputting image data, a motion detecting step of detecting a motion of the image data thus inputted, a cyclic coefficient determining step of determining a cyclic coefficient based on a result of the motion detection and a stored cyclic coefficient, a three-dimensional noise eliminating step of eliminating noises from the image data inputted in the image inputting step and the stored image data in accordance with the cyclic coefficient determined in the cyclic coefficient determining step, an image storing step of storing the image data whose noises have been eliminated in the three-dimensional noise eliminating step, and a cyclic coefficient storing step of storing the cyclic coefficient determined in the cyclic coefficient determining step. In the three-dimensional noise eliminating step, noises are eliminated in such a way that the image data inputted in the image inputting step is synthesized with the image data stored in the image storing step in accordance with the cyclic coefficient determined in the cyclic coefficient determining step. In the cyclic coefficient determining step, a new cyclic coefficient is determined based on the result of the motion detection and the stored cyclic coefficient in such a manner that a synthesizing ratio of the previous frame image stored in the image storing step will be less than a synthesizing ratio of the current frame image inputted in the image inputting step, with respect to the image data whose noises have been eliminated in the three-dimensional noise eliminating step.

Further, in the cyclic coefficient determining step, a new cyclic coefficient is determined based on the result of the motion detection made in the motion detecting step and the cyclic coefficient stored in the cyclic coefficient storing step, in the three-dimensional noise eliminating step, noises are eliminated from the image data inputted in the image inputting step and the image data stored in the image storing step in accordance with the cyclic coefficient determined in the cyclic coefficient determining step. The image inputting step, the motion detecting step, the cyclic coefficient determining step, the three-dimensional noise eliminating step, the image storing step, and the cyclic coefficient storing step are repeated.

The description hereinlater will be directed to the operation of, for example, a processor carrying out the above-mentioned program hereinlater with reference to FIG. 6.

Firstly, image data is continuously inputted (step S1), and a motion of the image data thus inputted is detected (step S2). Then, a cyclic coefficient is determined based on a result of the motion detection and the stored cyclic coefficient (step S3). A three-dimensional noise eliminating is carried out on the image data inputted in the step S1 and the stored image data in accordance with the cyclic coefficient determined in the step S3 (step S4). The image data whose noises have been thus eliminated is stored (step S5), and the cyclic coefficient determined in the cyclic coefficient determining step (step S3) is stored (step S6). In the three-dimensional noise eliminating step (step S4), noises are eliminated in such a way that the image data inputted in the image inputting step (step S1) is synthesized with the image data stored in the image storing step (step S5) in accordance with the cyclic coefficient determined in the cyclic coefficient determining step (step S3). In the cyclic coefficient determining step (step S3), a new cyclic coefficient is determined based on the result of the motion detection and the stored cyclic coefficient in such a manner that a synthesizing ratio of the previous frame image stored in the image storing step (step S5) will be less than a synthesizing ratio of the current frame image inputted in the image inputting step (step S1), with respect to the image data whose noises have been eliminated in the three-dimensional noise eliminating step (step S5).

Further, in the cyclic coefficient determining step (step S3), a new cyclic coefficient is determined based on the result of the motion detection made in the motion detecting step (step S2) and the cyclic coefficient stored in the cyclic coefficient storing step (step S6), in the three-dimensional noise eliminating step (step S4), noises are eliminated from the image data inputted in the image inputting step (step S1) and the image data stored in the image storing step (step S5) in accordance with the cyclic coefficient determined in the cyclic coefficient determining step (step S3). The image inputting step (step S1), the motion detecting step (step S2), the cyclic coefficient determining step (step S3), the three-dimensional noise eliminating step (step S4), the image storing step (step S5), and the cyclic coefficient storing step (step S6) are repeated.

The above-mentioned processes make it possible to prevent the cyclic coefficient from being rapidly changed from a low value to a high value and thus reduce time required to eliminate noises in motion pixels entered in the cyclic frames, resulting from the fact that a previous cyclic coefficient is stored, and a current cyclic coefficient is controlled based on not only the motion detection result but also information on the previous cyclic coefficient.

### INDUSTRIAL APPLICABILITY OF THE PRESENT INVENTION

As will be seen from the foregoing description, the image processing device according to the present invention is operative to determine a current cyclic coefficient based on not only a motion detection result but also information on the previous cyclic coefficient, thereby having an effect of preventing a cyclic coefficient from being rapidly changed from a low value to a high value and thus reducing time required to eliminate noises in motion pixels entered in the cyclic frames. The image processing device according to the present invention thus constructed is available as, for example, an image signal processing device using image signals composed of a plurality of frames to enhance a noise eliminating effect.

What is claimed is:

1. An image processing device, comprising:
image inputting means for continuously inputting image data;
image storing means for storing image data therein;
motion detecting means for detecting a motion of an image;
cyclic coefficient storing means for storing therein a cyclic coefficient to be used when referring to stored image data in order to eliminate noises from inputted image data;
cyclic coefficient determining means for determining a new cyclic coefficient based on a result of said motion detection and said stored cyclic coefficient;
three-dimensional noise eliminating means for eliminating noises from image data inputted by said image inputting means and image data stored in said image storing means, in accordance with said cyclic coefficient determined by said cyclic coefficient determining means, and in which
said image storing means is operative to store therein image data whose noises have been eliminated by said three-dimensional noise eliminating means, and
said cyclic coefficient storing means is operative to store therein a cyclic coefficient determined by said cyclic coefficient determining means.

2. An image processing device as set forth in claim 1, in which
said motion detecting means includes whole screen motion detecting means for detecting a motion in the whole screen, and pixel motion detecting means for detecting a motion in units of pixels based on a comparison between said image data inputted by said image inputting means and said image data stored in said image storing means, and
said cyclic coefficient determining means is operative to determine said new cyclic coefficient based on said motion in the whole screen, said motion in units of pixels, and said stored cyclic coefficient.

3. An image processing device as set forth in claim 1, in which
said motion detecting means is operative to detect a motion in units of pixels based on a comparison between said image data inputted by said image inputting means and said image data stored in said image storing means,
said cyclic coefficient storing means is operative to store therein cyclic coefficients determined by said cyclic coefficient determining means in units of pixels, and
said cyclic coefficient determining means is operative to determine new cyclic coefficients in units of pixels based on said motion in units of pixels, and said stored cyclic coefficients in units of pixels.

4. An image processing device as set forth in claim 1, in which
said image storing means further serves as said cyclic coefficient storing means and is operative to store therein said cyclic coefficient determined by said cyclic coefficient determining means in one or more lower bits of said image data.

5. An image processing device as set forth in claim 1, in which
said three-dimensional noise eliminating means is operative to eliminate noises in such a way that said image data inputted by said image inputting means is synthesized with said image data stored in said image storing means in accordance with said cyclic coefficient determined by said cyclic coefficient determining means, and
said cyclic coefficient determining means is operative to determine a new cyclic coefficient based on a result of said motion detection and said stored cyclic coefficient in accordance with a synthesizing ratio of a previous frame image stored in said image storing means and a synthesizing ratio of a current frame image inputted by said image inputting means, in said image data whose noises have been eliminated by said three-dimensional noise eliminating means.

6. An image processing program, comprising:
an image inputting step of continuously inputting image data;
a motion detecting step of detecting a motion of said inputted image data;
a cyclic coefficient determining step of determining a new cyclic coefficient based on a result of said motion detection and a stored cyclic coefficient;
a three-dimensional noise eliminating step of eliminating noises from said image data inputted in said image inputting step and said stored image data in accordance with said cyclic coefficient determined in said cyclic coefficient determining step,
an image storing step of storing said image data whose noises have been eliminated in said three-dimensional noise eliminating step, and
a cyclic coefficient storing step of storing said cyclic coefficient determined in said cyclic coefficient determining step, and in which
said cyclic coefficient determining step has a step of determining a new cyclic coefficient based on said result of said motion detection detected in said motion detecting step and said cyclic coefficient stored in said cyclic coefficient storing step,
said three-dimensional noise eliminating step has a step of eliminating noises from said image data inputted in said image inputting step and said image data stored in said image storing step in accordance with said cyclic coefficient determined in said cyclic coefficient determining step, and
said image inputting step, said motion detecting step, said cyclic coefficient determining step, said three-dimensional noise eliminating step, said image storing step, and said cyclic coefficient storing step are repeated.

7. An image processing program as set forth in claim 6, in which
said three-dimensional noise eliminating step has a step of eliminating noises in such a way that said image data inputted in said image inputting step is synthesized with said image data stored in said image storing step in accordance with said cyclic coefficient determined in said cyclic coefficient determining step, and
said cyclic coefficient determining step has a step of determining a new cyclic coefficient based on said result of said motion detection and said stored cyclic coefficient in accordance with a synthesizing ratio of a previous frame image stored in said image storing step and a synthesizing ratio of said current frame image inputted in said image inputting step, with respect to said image data whose noises have been eliminated in said three-dimensional noise eliminating step.
